(19) United States
(12) Patent Application Publication
(10) Pub. No.: US 2025/0078131 A1
(43) Pub. Date: Mar. 6, 2025

(54) METHOD AND SYSTEM OF CREATIVE CONTENT DISCOVERY AND SELECTIVE ENGAGEMENT THEREWITH

(71) Applicant: JOYCELYN DAVID, TORONTO (CA)

(72) Inventor: JOYCELYN DAVID, TORONTO (CA)

(21) Appl. No.: 18/825,300

(22) Filed: Sep. 5, 2024

Related U.S. Application Data
(60) Provisional application No. 63/536,884, filed on Sep. 6, 2023.

(51) Int. Cl. G06Q 30/0601

(52) U.S. Cl. CPC G06Q 30/0629

(57) ABSTRACT

Method and system of discovering and engaging creative media in a content provisioning platform. The method comprises receiving a request, via the content provisioning platform, that specifies a genre of creative content data and content filtering criteria, discovering, responsive to the request, at least one content item created in accordance with the content filtering criteria and engaging a content provider associated with the content item based at least in part upon the content filtering criteria in conjunction with consent rules associated with the content item.

### RELATED APPLICATION

This application claims benefit of priority to U.S. Provisional Patent Application No. 63/536,884 filed Sep. 6, 2023. Said U.S. Provisional Patent Application No. 63/536,884 is hereby incorporated in its entirety.

### TECHNICAL FIELD

The disclosure herein relates to content discovery and selective engagement of multi-cultural, multi-channel media content types in a content provisioning platform of a network system.

### BACKGROUND

A business critical goal that businesses seek relate to multi-cultural representation by way of diversity, equity and inclusion (DEI) in marketing solutions. A significant barrier to achieving the business critical goal, however, is that currently less than 20% of businesses' marketing budget is invested in actual diverse and multicultural marketing channels and associated media content, falling well short of, and presenting a barrier to, their DEI aspirations. In an effort to enable planning and execution of multicultural marketing programs, solely using existing media content marketplace channels may have an unanticipated or unintended result of locking local and ethnic creators of media content out of contention and opportunity for acquisition or adoption of their creative content, at least in part due to the limited discoverability of, and therefore accessibility to, such creative content.

### BRIEF DESCRIPTION OF THE DRAWINGS

FIG. 1 illustrates, in an example embodiment, a server-based content provisioning platform.

FIG. 2 illustrates, in one example embodiment, an architecture of a server-based content provisioning platform.

FIG. 3 illustrates, in an example embodiment, a scheme for discovery and acquisition of creative content in a media marketplace.

FIG. 4 illustrates, in an example embodiment, a method of operation, in a content provisioning platform, of discovering creative content in a media marketplace and engaging therewith.

FIG. 5 illustrates, in an example embodiment, a further method of operation, in a content provisioning platform, of discovering creative content in a media marketplace and engaging therewith.

### DETAILED DESCRIPTION

Among other technical advantages and benefits, solutions provided herein provide a content provisioning platform system that enhances multicultural global digital commerce penetration multiculturally across nations, cultures, geographic regions and localities, and languages. The disclosure herein enables a system for use by small entity or even individual creators of artistic works to meet a long-felt need to have their products become discoverable by a larger number of potential buyers. Or stated alternatively, to have their artistic works become readily accessible to a larger number of potential buyers across the world, thus enabling increased likelihood of acquisition of their works by such buyers. A multi-cultural creative marketplace thus provided enables content creators with increased accessibility to potential buyers and consumers of their authored content.

Particular embodiments disclosed herein enable a content provider of artistic works intended for media consumption to define and deploy a set of consent rules specifying their preferences regarding usage of their content for sale. The consent rules consent rules can be defined or specified by a seller of the content item, restricting permitted field(s) of use, manner of use, a term of use, a restriction on intellectual property rights being conferred by way of usage, and a monetary fee demand for the content item being sold to a potential buyer. In this manner, the consent rules, in conjunction with content filtering rules defined by a potential buyer, may be applied to achieve selective engagement in which a seller's preferences with regard to use of their creative work may be matched with the marketing usage objectives of a prospective buyer. Such selective engagement based on the matching promotes significantly enhanced likelihood of discoverability of the creative content and paves the way for efficient commercial transactions that advance both buyers' and sellers' commercial goals, while advancing adoption and deployment of multicultural media works in multicultural marketing solutions, consistent with DEI aspirations and business objectives. In some aspects, a “one stop shop” for creative, authored content in a marketplace of multicultural media that includes traditional, offline, and online digital multicultural media and for discovery and acquisition by consumers of the multicultural media is provided, while simultaneously advancing media visibility for a growing community of ethnic influencers in the realm of creative media content.

Embodiments herein further recognize a need for providing sellers control of third party access and usage over their data content and intellectual property as created. Some embodiments herein provide for deploying techniques to monetize a content creator's intellectual property (IP) rights. In some aspects, embodiments herein enable monetizing a content creator's IP rights over a content provisioning platform, and enabling or facilitating payments, including content licensing fees, directly to content creators or content owners via the content provisioning platform.

Embodiments herein also focus on a company or entity as a buyer of IP rights (also referred to herein as a “buyer”) in created content as perfected by a creator or author of such content (also referred to herein as a “seller”), based on the selective engagement solution that improves upon current established systems that may inherently limit discoverability of, access to, and acquisition of such content, while retaining privacy of both the buyer party and the content creator as seller party, including terms of any licensing or content asset transactions entered into. In embodiments, a content provider as referred to herein means a content creator who creates or authors content, including content intended for media, and also a third party or agent who may have acquired an associated ownership right in intellectual property associated with the content as created.

In accordance with a first example embodiment, a method performed in one or more processors of a server computing device of a content provisioning platform is disclosed. The method comprises receiving a request, via the content provisioning platform, that specifies a genre of creative content data and a set of content filtering criteria, discovering, responsive to the request, at least one content item created in accordance with the set of content filtering criteria, and engaging at least one content provider associated with the at least one content item based at least in part upon the set of content filtering criteria in conjunction with a set of consent rules associated with the at least one content item.

In accordance with a second example embodiment, also provided is a computing system, which may be a networked server computer, or a subscriber client computer deployed in an edge computing networked arrangement, for provisioning content as created. The computing system includes a processor and a memory storing instructions executable in the processor. The instructions, when executed in the processor, cause the processor to perform operations including receiving a request, via a content provisioning platform, that specifies a genre of creative content data and a set of content filtering criteria, discovering, responsive to the request, at least one content item created in accordance with the set of content filtering criteria, and engaging at least one content provider associated with the at least one content item based at least in part upon the set of content filtering criteria in conjunction with a set of consent rules associated with the at least one content item.

Also provided is a non-transitory, computer readable memory storing instructions executable in a processor device. The instructions, when executed in the processor device, cause the processor to perform operations including receiving a request, via a content provisioning platform, that specifies a genre of creative content data and a set of content filtering criteria, discovering, responsive to the request, at least one content item created in accordance with the set of content filtering criteria, and engaging at least one content provider associated with the at least one content item based at least in part upon the set of content filtering criteria in conjunction with a set of consent rules associated with the at least one content item.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more non-transitory memory resources of the computing device.

Furthermore, one or more embodiments described herein may be implemented through the use of logic instructions that are executable by one or more processors of a computing device, including a server computing device. These instructions may be stored on a computer-readable medium. In particular, machines shown with embodiments herein include processor(s) and various forms of memory for storing data and instructions. Examples of computer-readable mediums and computer storage mediums include portable memory storage units and flash memory (such as carried on smartphones). A server computing device as described herein utilizes processors, memory, and logic instructions stored in the memory or computer-readable medium. Embodiments described herein may be implemented in the form of computer processor-executable logic instructions or programs stored on computer-readable memory mediums.

### System Description

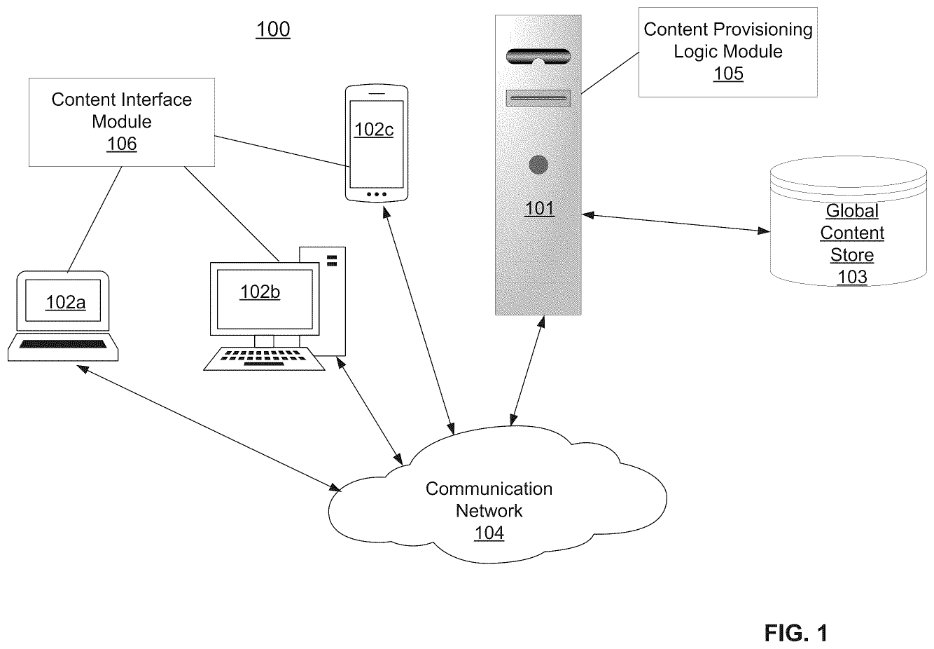

FIG. 1 illustrates, in an example embodiment, server-based content provisioning platform 100. While content provisioning server device 101 may include content provisioning logic module 105 as depicted, it is contemplated that, in alternate embodiments, computing devices 102a-c, including desktop workstations, laptop computers, and mobile computing devices 102a-c in communication via network 104 with content provisioning server 101, may include one or more sub-modules or portions that constitute content provisioning logic module 105 as embodied in computer processor-executable instructions stored within a non-transitory computer readable memory. Global content store 103, embodied in a database storage medium, may be communicatively accessible to content provisioning server device 101 (also referred to as server 101 herein) and also to one or more of computing devices 102a-c (also collectively referred to herein as computing device 102) via communication network 104.

Computing devices 102a-c may be configured to include client interface module 106 constituted of processor-executable instructions, allowing interaction by a user, whether a seller or a buyer of creative content, at computing devices 102a-c with results generated from, or in conjunction with, content provisioning logic module 105 at content provisioning server 101. In one embodiment, client interface module 106 includes processor-executable instructions or a software application downloadable from content provisioning server device 101 and configured to operate in conjunction with content provisioning logic module 105 to allow physical user interface representations of the sentiment community at computing device 102. It is contemplated that, in alternate embodiments, client interface module 106 may include one or more sub-modules or portions that constitute content provisioning logic module 105 as embodied in computer processor-executable instructions stored within a non-transitory computer readable memory, and executable in a processor of client device 102.

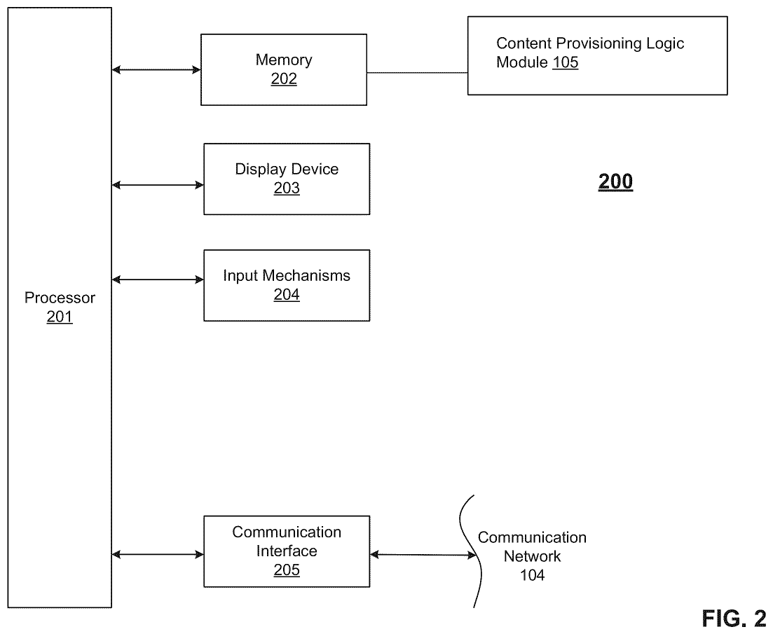

FIG. 2 illustrates, in one example embodiment, an architecture 200 of content provisioning server 105 hosting content provisioning logic module 105. Content provisioning server device 101 may include processor 201, non-transitory computer readable memory 202 that includes content provisioning logic module 105, display screen 203, input mechanisms 204 such as a keyboard or software-implemented touchscreen input functionality, and communication interface 207 for communicating with client devices 102a-c via communication network 104.

Content provisioning logic module 105 includes instructions stored in memory 202 of content provisioning server 101, the instructions being executable in processor 201 for receiving a request, via content provisioning platform 100, that specifies a genre of creative content data and a set of content filtering criteria. The term genre as used herein means a category of artistic, musical, literary or similar creative work, including as reduced to any form of data content, including media works, as characterized by a particular style, form, content or technique of creation or production.

The content item may include one or more of an audio content portion, an image content portion, a video content portion, a website content portion, a text content portion, a product review, a services review, and social media content data associated with one or more of a hashtag, a social media handle, and a message exchange. In embodiments, the content item is associated with one or more of a provider account, a pointer or a link to a designated storage space within a storage medium, one or more authors or creators of the at least one content item, a monetary fee amount and a link to at least one financial payment account. In some aspects, the provider may be the actual author or creator of the content item. In other aspects, the provider may be a third party or agent who has been assigned intellectual property rights by the author or creator of the content item, sufficient in order to enter into a license agreement with a potential buyer or buyers. In either case, the financial payment account associated with the provider allows for direct payment from a buyer to a seller upon consummation of an agreement for provision of content items.

In embodiments, the set of content filtering criteria comprises one or more of a language, a dialect, a cultural affiliation, a cultural event, a social affiliation, a geographic region or country, a locale, an age demographic for both or either of the creators of the content item and a target or intended audience of the content item, a content genre, a musical genre, a video genre, a product marketing attribute, a services marketing attribute, and a social attribute associated with one or more authors of the content item. It is contemplated that other filtering criteria may be deployed in order to target certain demographics, based on social, multicultural, and other applicable or identifying attributes as desired by prospective buyers of creative content.

Processor 201 executes instructions of content provisioning logic module 105 for discovering, responsive to the request, one or more creative content items based on the set of content filtering criteria. In this manner, content filtering may be deployed to advance marketing solutions that target or cater to specific multicultural audience demographics, based on social, multicultural, and other desired identifying attributes. Processor 201 may further execute instructions of content provisioning logic module 105 for engaging at least one content provider associated with the at least one content item based at least in part upon the set of content filtering criteria in conjunction with a set of consent rules associated with the at least one content item. The consent rules consent rules can be defined or specified by a seller of the content item, restricting permitted field(s) of use, manner of use, a term of use, a restriction on intellectual property rights being conferred by way of usage, and a monetary fee demand for the content item being sold to a potential buyer. In this manner, the consent rules and content filtering rules may be applied to achieve selective engagement in which a seller's preferences with regard to use of their creative work may be matched with the marketing usage objectives of a prospective buyer.

In related or additional embodiments, processor 201 further executes instructions of content provisioning logic module 105 for rendering, at a display interface of a computing device 102a-c, a solicitation for acceptance of an offer that includes a monetary fee amount, or a licensing fee, in exchange for at least partial usage rights pertaining to the content item, and for receiving, responsive to acceptance of the offer, one or more of (i) the content item, and (ii) information that enables accessing, at a designated storage location within a storage medium, the content item. In some aspects, the storage medium may be a secure immutable storage medium in accordance with a blockchain based storage configuration that is configured to enact the commercial transaction as described herein between buyer and seller parties.

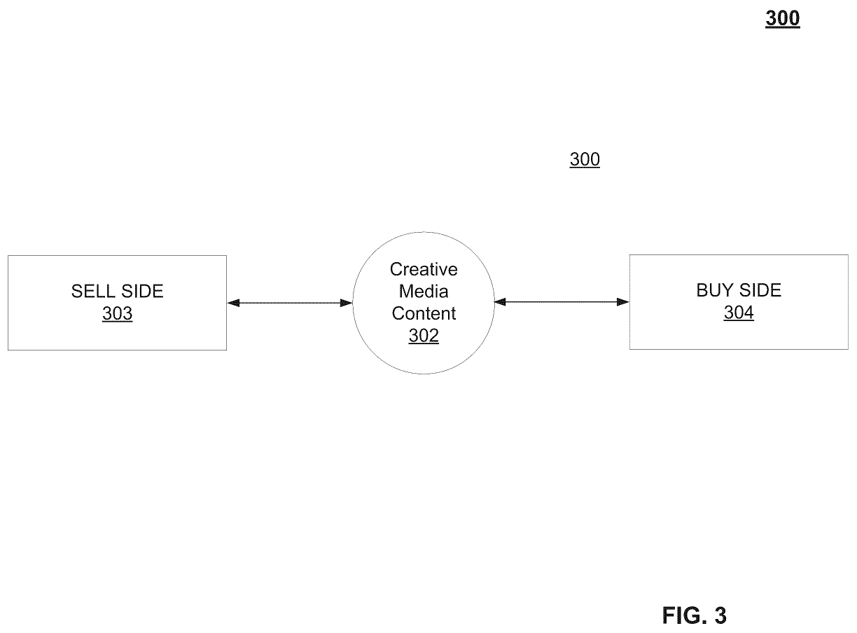

FIG. 3 illustrates, in an example embodiment, scheme 300 in a content provisioning platform for discovery and acquisition of media content 302, including creative content, in a media marketplace by way of a commercial transaction between buy side 304 representing a buyer and sell side 303 representing a seller of the created work as manifested by the created content. The transaction between buy side 304 and sell side 303 in accordance with FIG. 3 enables a system for use by small entity or even individual creators of artistic works to have their products made readily discoverable by a large number of potential buyers across different cultures and sub-cultures around the world, thus increasing likelihood of acquisition of the creative works by prospective buyers. The multi-cultural creative media marketplace thus provided enables content creators with increased accessibility to potential buyers and consumers of their authored content.

Buy side 304 examples may include, but are not necessarily limited to, more traditional, established entities such as agency trade desks, independent trade desks, research entities, demand side platforms (DSPs), Data Suppliers and Advertising Verification entities. Data management platforms (DMPs) represent a centralized computing system that allows the collection of audience intelligence attributes by advertisers and agencies, thereby allowing better ad targeting. Advanced DMPs may offer users the ability to create custom segments, forecast segment volumes, sync segments with other sources, overlay advanced analytics and are often integrated with, or part of, one or more DSP platform(s). Agency trade desks may represent a department, or arm of an agency, that oversees programmatic buying. Many agency holding companies have a trading desk. Ad Verification entities may provide a service that offers technology to ensure that ads appear on intended sites and reach the targeted audience as defined by the advertiser. DSPs represent a technology platform through which buyers (advertisers or agencies) can plan, target, execute, optimize, and analyze digital media buying programs across a given media plan. Through a DSP, the buyer can set ad targeting criteria, pricing, frequency, and other criteria governing the purchase of digital ad units across multiple sources including ad exchanges, ad networks and sell side platforms. Advanced DSPs may provide additional capabilities to the buyer, including integration of various online and offline data sources and the ability to provision direct media buys, and are also known as buy side optimizer or buy side platform. Independent trade desks may be such as a company that transacts programmatically using DSP technology on behalf of advertisers and agencies, that is media agnostic (i.e.: where inventory is not owned and operated by a publisher network). Research entities may include recognized third party data providers that offers data or information about audiences in an aggregate form including trends, publisher or advertiser insights, pre/post campaign analysis and similar as a nonbiased source.

Sell side 303 examples may include, but not be necessarily limited to, individuals, small entities, advertising networks, advertising servers, advertising exchanges, and sell side platforms (SSPs). Advertising exchanges may be a sales channel between publishers and ad networks, that can provide aggregated media content inventory to advertisers, typically powered by proprietary technology in content provisioning platform 100 configured to facilitate automated auctions based on pricing and buying in real-time. Advertising networks include companies that offer direct integration with specific publishers and provide an outsourced sales capability for publishers, and a means to aggregate inventory and audiences from numerous sources in a single buying opportunity for media buyers. Ad networks may provide specific technologies to enhance value to both publishers and advertisers, including unique targeting capabilities, creative generation, and optimization. Ad networks' business models and practices may include features that are similar to those offered by ad exchanges. Ad servers typically are dedicated to the delivery of an ad, storing digital advertisements and delivering them to website visitors, monitoring marketing campaigns and creating reports on advertising related metrics. Ad servers may be either buy side and/or sell side implementations in some embodiments. SSPs may embody a technology platform that enables publishers of web content to manage their advertising inventory and is similar to an ad network by aggregating inventory for revenue optimization. Impression media content inventory managed by SSPs are often purchased by DSPs or ad networks. Sell side 303 may also include content streamers who provide or operate infrastructure to enable audio streaming, or a publisher who has audio content available and allows for audio formats to be made available programmatically. [00.] The term selective engagement, or engagement, as used herein refers to a process of matching the IP asset as manifested in the creative content made available by a seller with a prospective buyer in a manner that fulfils buyer requirements or criteria, wherein a content item, or content asset, is matched with the buyer's requirements based on content filtering criteria as defined or specified by the buyer.

In embodiments, a prospective buyer of content may register their interest, for example via the content provisioning server 105, in accordance with content filtering criteria which is targeted to engage selectively with certain creators of media content based on topics, events and contexts of interest. In some aspects, the registration may be curated for delivery to prospective sellers based on such criteria as a product name, a service, a context that specifies a place or things, or even a sentiment type that includes positive and/or negative sentiment types. Buyers representing brands, organizations and other buyer entities may register with the content provisioning network 100 as prospective buyers of content assets made available for sale or licensing by sellers. In related aspects, buyers may also create blacklists of contexts, events and other content in which they are not interested, so that sellers associated with creation of such content are selectively precluded from engagement. In additional embodiments, since content may be stored in designated unique locations in, for instance, blockchain configurations is secure and confidential, the buyer retains privacy in regard to asset transactions with a given seller. in some embodiments, buyers may request future alerts by content provisioning platform 100 whenever a given seller creates or otherwise acquires new content assets and adds same to the blockchain for acquisition by prospective buyers. In some embodiments, content provisioning network 100 enables transmitting, to a designated financial account associated with the user, a payment amount in accordance with a licensing fee monetary amount as agreed upon between buyer and seller.

### Methodology

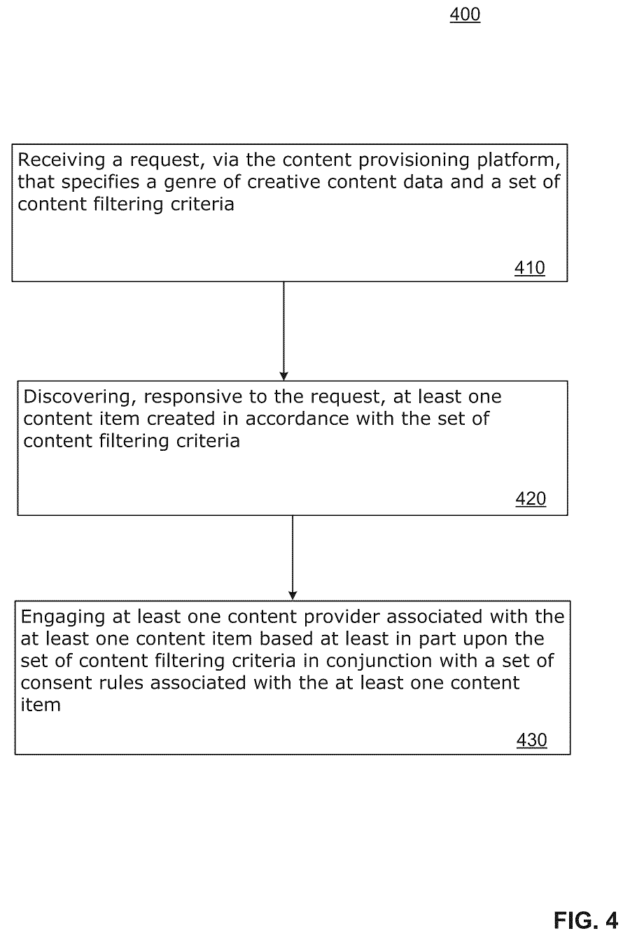

FIG. 4 illustrates, in an example embodiment, a method of operation 400, in a content provisioning platform, of discovering creative content in a media marketplace and engaging therewith. In describing the example of FIG. 4, reference is made to the examples of FIG. 1 through FIG. 3 for purposes of illustrating suitable components or elements in performing a step or sub-step being described.

Examples of method steps described herein relate to the use of content provisioning server device 101 including content provisioning logic module 105 for implementing the techniques described. According to one embodiment, the techniques are performed by content provisioning server device 101 in response to the processor 201 executing one or more sequences of software logic instructions that constitute content provisioning logic module 105. Such software logic instructions may be read into memory 202 from machine-readable medium such as memory storage devices. In executing the sequences of instructions contained in content provisioning logic module 105, processor 201 performs the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions.

At step 410, processor 201 executes instructions of content provisioning logic module 105 for receiving a request, via the content provisioning platform 100, that specifies a genre of creative content data and a set of content filtering criteria. The term genre as used herein means a category of artistic, musical, literary or similar creative work, including as reduced to any form of data content, including media works, as characterized by a particular style, form, content or technique of creation or production.

The content item may include one or more of an audio content portion, an image content portion, a video content portion, a website content portion, a text content portion, a product review, a services review, and social media content data associated with one or more of a hashtag, a twitter handle, and a message exchange. In embodiments, the content item is associated with one or more of a provider account, a pointer or a link to a designated storage space within a storage medium, one or more authors or creators of the at least one content item, a monetary fee amount and a link to at least one financial payment account. In some aspects, the provider may be the actual author or creator of the content item. In other aspects, the provider may be a third party or agent who has been assigned intellectual property rights by the author or creator of the content item, sufficient in order to enter into a license agreement with a potential buyer or buyers. In either case, the financial payment account associated with the provider allows for direct payment from a buyer to a seller upon consummation of an agreement for provision of content items.

In embodiments, the set of content filtering criteria comprises one or more of a language, a dialect, a cultural affiliation, a social affiliation, a geographic region or country, a locale, an age demographic for both or either of the creators of the content item and a target or intended audience of the content item, a content genre, a musical genre, a video genre, a product marketing attribute, a services marketing attribute, and a social attribute associated with one or more authors of the content item. It is contemplated that other filtering criteria may be deployed in order to target certain demographics, based on social, multicultural, and other applicable or desired identifying attributes.

At step 420, processor 201 executes instructions of content provisioning logic module 105 for discovering, responsive to the request, at least one content item created in accordance with the set of content filtering criteria. In this manner, content filtering may be deployed to advance marketing solutions that target or cater to specific multicultural audience demographics, based on social, multicultural, and other desired identifying attributes.

At step 430, processor 201 executes instructions of content provisioning logic module 105 for engaging at least one content provider associated with the at least one content item based at least in part upon the set of content filtering criteria in conjunction with a set of consent rules associated with the at least one content item. The consent rules consent rules can be defined or specified by a seller of the content item, restricting permitted field(s) of use, manner of use, a term of use, a jurisdiction or locale for usage, a restriction on intellectual property rights being conferred by way of usage, and a monetary fee demand for the content item being sold to a potential buyer. In this manner, the consent rules and content filtering rules may be applied to achieve selective engagement in which a seller's preferences with regard to use of their creative work may be matched with the marketing usage objectives of a prospective buyer.

Additionally, it is further contemplated that in alternative embodiments, the techniques herein, or portions thereof, may be distributed between client, or subscriber, computing devices 102a-c and content provisioning server device 101. For example, computing devices 102a-c may perform some portion of functionality described herein with regard to various modules of which content provisioning logic module 105 is comprised, and transmit data to content provisioning server 101 that, in turn, performs at least some portion of the techniques described herein.

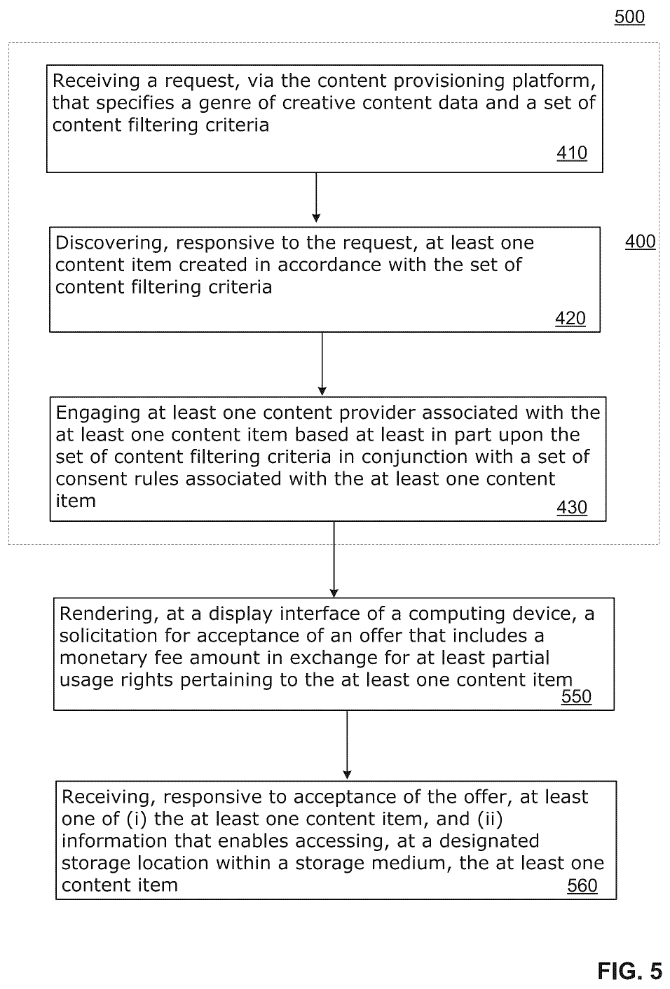

FIG. 5 illustrates, in an example embodiment, method of operation 500, in a content provisioning platform, for discovering creative content in a media marketplace and engaging therewith. In describing the example of FIG. 5, reference is made to the examples of FIG. 1 through FIG. 4 for purposes of illustrating suitable components or elements in performing a step or sub-step being described.

Examples of method steps described herein relate to the use of content provisioning server device 101 including content provisioning logic module 105 for implementing the techniques described. According to one embodiment, the techniques are performed by content provisioning server device 101 in response to the processor 201 executing one or more sequences of software logic instructions that constitute content provisioning logic module 105. In embodiments, content provisioning logic module 105 may include the sequences of instructions that may be read into memory 202 from machine-readable medium, such as memory storage devices. In executing the sequences of instructions contained in content provisioning logic module 105, processor 201 performs the process steps as described herein, including with regard to FIG. 5. In alternative implementations, at least some hard-wired circuitry may be used in place of, or in combination with, the software logic instructions to implement examples described herein. Thus, the examples described herein are not limited to any particular combination of hardware circuitry and software instructions.

Additionally, it is further contemplated that in alternative embodiments, the techniques herein, or portions thereof, may be distributed between client, or subscriber, computing devices 102a-c and content provisioning server device 101. For example, computing devices 102a-c may perform some portion of functionality described herein with regard to various modules of which content provisioning logic module 105 is comprised, and transmit data to content provisioning server 101 that, in turn, performs at least some portion of the techniques described herein.

At step 550, processor 201 executes instructions of content provisioning logic module 105 for rendering, at a display interface of a computing device 102a-c, a solicitation for acceptance of an offer that includes a monetary fee amount, or a licensing fee, in exchange for at least partial usage rights pertaining to the content item.

At step 560, processor 201 executes instructions of content provisioning logic module 105 for receiving, responsive to acceptance of the offer, one or more of (i) the content item, and (ii) information that enables accessing, at a designated storage location within a storage medium, the content item. In some embodiments, the storage medium may be a secure immutable storage medium in accordance with a blockchain based storage configuration.

In some embodiments, the method further includes transmitting, to a financial account associated with the content provider, a payment of the monetary fee amount in acceptance of the offer for buying and selling the content item. It is additionally contemplated that a buyer may be interested in getting future notifications upon the author(s) of the content item having completed similar works in the future that the given buyer might be interested in acquiring rights thereto, whereby an author's ownership right in those additional works is created in at the time of completion of the work in accordance with prevailing jurisdictional copyright laws.

It is also contemplated, in some embodiments, the techniques herein or portions thereof may be distributed between computing devices 102a-c and content provisioning server device 101. For example, computing devices 102a-c, as deployed by either buyers or sellers as described herein, may perform some portion of functionality described herein with regard to content provisioning logic module 105 and transmit data to content provisioning server 101 that, in turn, performs at least some portion of the techniques described herein.

It is contemplated that embodiments described herein extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments as described herein. Thus, the absence of describing combinations should not preclude the inventors from claiming rights to such combinations.

What is claimed is:

1. A method, performed in one or more processors of a server computing device of a content provisioning platform, the method comprising:
receiving a request, via the content provisioning platform, that specifies a genre of content data and a set of content filtering criteria;
discovering, responsive to the request, at least one content item created in accordance with the set of content filtering criteria; and
engaging at least one content provider associated with the at least one content item based at least in part upon the set of content filtering criteria in conjunction with a set of consent rules associated with the at least one content item.

2. The method of claim 1 wherein the at least one content item comprises at least one of: an audio content portion, an image content portion, a video content portion, a website content portion, a text content portion, a product review, a services review, and social media content data associated with one or more of a hashtag, a social media handle, and a message exchange.

3. The method of claim 1 wherein the set of content filtering criteria comprises at least one of: a language, a dialect, a cultural affiliation, a cultural event, a social affiliation, a geographic region or country, a locale, an age demographic, a content genre, a musical genre, a video genre, a product marketing attribute, a services marketing attribute, and a social attribute associated with one or more authors of the content item.

4. The method of claim 1 wherein the at least one content item is further associated with at least one of: a provider account, a pointer or a link to a designated storage space within a storage medium, one or more authors or creators of the at least one content item, a monetary fee amount and a link to at least one financial payment account.

5. The method of claim 1 wherein the set of consent rules specify, in relation to the at least one content item, at least one of: a permitted field of use, a permitted manner of use, a term of use, a jurisdiction or locale of usage, a restriction on intellectual property rights being conferred by way of usage, and a monetary fee demand.

6. The method of claim 1 wherein the engaging further comprises:
rendering, at a display interface of a computing device, a solicitation for acceptance of an offer that includes a monetary fee amount in exchange for at least partial usage rights pertaining to the at least one content item.

7. The method of claim 6 further comprising:
receiving, responsive to acceptance of the offer, at least one of (i) the at least one content item, and (ii) information that enables accessing, at a designated storage location within a storage medium, the at least one content item.

8. The method of claim 7 wherein the storage medium comprises a blockchain.

9. The method of claim 7 further comprising transmitting, to a financial account associated with the at least one content provider, a payment of the monetary fee amount in acceptance of the offer.

10. The method of claim 6 wherein the offer further comprises a solicitation for a future notification upon one or more authors of the at least one content item having perfected an ownership right in at least one additional content item.

11. A server computing system comprising:
one or more processors;
a memory storing a set of instructions, the instructions when executed in the one or more processors causing the one or more processors to implement operations comprising:
receiving a request, via a content provisioning platform, that specifies a genre of content data and a set of content filtering criteria;
discovering, responsive to the request, at least one content item created in accordance with the set of content filtering criteria; and
engaging at least one content provider associated with the at least one content item based at least in part upon the set of content filtering criteria in conjunction with a set of consent rules associated with the at least one content item.

12. The server computing system of claim 1 wherein the at least one content item comprises at least one of: an audio content portion, an image content portion, a video content portion, a website content portion, a text content portion, a product review, a services review, and social media content data associated with one or more of a hashtag, a social media handle, and a message exchange.

13. The server computing system of claim 1 wherein the set of content filtering criteria comprises at least one of: a language, a dialect, a cultural affiliation, a cultural event, a social affiliation, a geographic region or country, a locale, an age demographic, a content genre, a musical genre, a video genre, a product marketing attribute, a services marketing attribute, and a social attribute associated with one or more authors of the content item.

14. The server computing system of claim 1 wherein the at least one content item is further associated with at least one of: a provider account, a pointer or a link to a designated storage space within a storage medium, one or more authors or creators of the at least one content item, a monetary fee amount and a link to at least one financial payment account.

15. The server computing system of claim 1 wherein the set of consent rules specify, in relation to the at least one content item, at least one of: a permitted field of use, a permitted manner of use, a term of use, a jurisdiction or locale of usage, a restriction on intellectual property rights being conferred by way of usage, and a monetary fee demand.

16. The server computing system of claim 1 wherein the engaging further comprises instructions executable for rendering, at a display interface of a computing device, a solicitation for acceptance of an offer that includes a monetary fee amount in exchange for at least partial usage rights pertaining to the at least one content item.

17. The server computing system of claim 6 further comprising instructions executable for receiving, responsive to acceptance of the offer, at least one of (i) the at least one content item, and (ii) information that enables accessing, at a designated storage location within a storage medium, the at least one content item.

18. The server computing system of claim 17 further comprising instructions executable for transmitting, to a financial account associated with the at least one content provider, a payment of the monetary fee amount in acceptance of the offer.

19. The server computing system of claim 16 wherein the offer further comprises a solicitation for a future notification upon one or more authors of the at least one content item having perfected an ownership right in at least one additional content item.

20. A non-transitory, computer readable medium storing instructions, the instructions being executable in a processor, and which, when executed in the processor, causing the processor to implement operations comprising:
receiving a request, via the content provisioning platform, that specifies a genre of content data and a set of content filtering criteria;
discovering, responsive to the request, at least one content item created in accordance with the set of content filtering criteria; and
engaging at least one content provider associated with the at least one content item based at least in part upon the set of content filtering criteria in conjunction with a set of consent rules associated with the at least one content item.
